(19) United States
(12) Patent Application Publication
(10) Pub. No.: US 2019/0064782 A1
(43) Pub. Date: Feb. 28, 2019

(54) MACHINE TOOL AND ROBOT LINKING SYSTEM

(71) Applicant: FANUC Corporation, Yamanashi (JP)

(72) Inventor: Zheng TONG, Yamanashi (JP)

(21) Appl. No.: 16/103,930

(22) Filed: Aug. 15, 2018

(30) Foreign Application Priority Data
Aug. 22, 2017 (JP) 2017-159700

(51) Int. Cl. G05B 19/418; B23Q 7/04; B25J 13/08

(52) U.S. Cl. CPC G05B 19/41825; G05B 2219/39001; B25J 13/089; B23Q 7/046

(57) ABSTRACT

A linking system is a system for linking operations of a machine tool and a robot. The linking system includes a transmission side device and a reception side device, one of which is the machine tool or a controller thereof and the other one of which is the robot or a controller thereof. The transmission side device includes position information generation unit configured to generate position-related information of the transmission side device and transmission unit configured to transmit the position-related information to the reception side device. The reception side device includes reception unit configured to receive the position-related information from the transmission side device and coordinate transformation unit configured to transform the position-related information to a coordinate system of the reception side device.

### BACKGROUND OF THE INVENTION

### 1. Field of the Invention

The present invention relates to a machine tool and robot linking system, and particularly relates to a machine tool and robot linking system in which a machine tool and a robot can share information such as positions of each other.

### 2. Description of the Related Art

Conventionally, in a system of linking a machine tool and a robot, basically both are not simultaneously operated at close range in order to avoid interference. When both are to be operated at close range, the interference is avoided by notifying an opposite party of an operation completion signal and performing a sequential operation or the like.

An example of the sequential operation using the operation completion signal will be illustrated. A system in which a machine tool processes a workpiece and a robot holds and moves the processed workpiece is considered. The machine tool notifies the robot of a completion signal when processing is completed. When the completion signal is received, the robot performs an operation of holding and moving the processed workpiece. When the operation is completed, the robot notifies the machine tool of a completion signal. When the completion signal is received, the machine tool starts the processing of the next workpiece. Similarly, at system-up, that is, in the case of unloading the robot, the machine tool and the robot also notify each other of the completion signal to avoid the interference.

However, the system in which the machine tool and the robot perform a sequential linking operation has a problem that productivity of the system is limited. In addition, the system-up using the operation completion signal has a problem that the operation is complicated.

As a solution to such problems, Japanese Patent Laid-Open No. 8-202419 discloses a system in which output data of an encoder attached to a main axis of a press is outputted from a press machine to a robot controller, and the robot controller converts the output data of the encoder to crank angle data indicating a press crank angle and determines in what operation area the press machine is positioned based on the crank angle data. That is, in the system, the press machine notifies the robot controller of information regarding a position of the main axis and thus, a linking operation of the press machine and a robot is performed. However, a machine tool performs various operations without being limited to a simple crank rotating operation as described in Japanese Patent Laid-Open No. 8-202419. The same is true of the operations of the robot. A generalized linking method by which the machine tool and the robot can notify each other of information such as positions changing accompanying such various operations has not been provided yet.

### SUMMARY OF THE INVENTION

The present invention is implemented to solve such problems, and an object is to provide a machine tool and robot linking system in which a machine tool and a robot can share information such as positions of each other.

A linking system pertaining to an embodiment of the present invention is a system for linking operations of a machine tool and a robot, and includes a transmission side device and a reception side device, one of which is the machine tool or a controller thereof and the other one of which is the robot or a controller thereof. The transmission side device includes position information generation unit configured to generate position-related information of the transmission side device and transmission unit configured to transmit the position-related information to the reception side device, and the reception side device includes reception unit configured to receive the position-related information from the transmission side device and coordinate transformation unit configured to transform the position-related information to a coordinate system of the reception side device.

In a linking system pertaining to an embodiment of the present invention, the position-related information is output of a pulse coder or an encoder of the transmission side device.

A linking system pertaining to an embodiment of the present invention is a system for linking operations of a machine tool and a robot, and includes a transmission side device and a reception side device, one of which is the machine tool or a controller thereof and the other one of which is the robot or a controller thereof, and a position information acquisition device. The position information acquisition device includes position information generation unit configured to generate position-related information of the transmission side device, and the reception side device includes coordinate transformation unit configured to transform the position-related information to a coordinate system of the reception side device.

In a linking system pertaining to an embodiment of the present invention, the position information acquisition device includes image pickup unit configured to acquire an image of the transmission side device, and the position information generation unit generates the position-related information based on the image.

A linking system pertaining to an embodiment of the present invention is a system for linking operations of a machine tool and a robot, and includes a transmission side device and a linking destination device, one of which is the machine tool or a controller thereof and the other one of which is the robot or a controller thereof, and a reception side device. The transmission side device includes position information generation unit configured to generate position-related information of the transmission side device and transmission unit configured to transmit the position-related information to the reception side device, and the reception side device includes reception unit configured to receive the position-related information from the transmission side device and coordinate transformation unit configured to transform the position-related information to a coordinate system of the reception side device and output the information to the linking destination device.

A linking system pertaining to an embodiment of the present invention is a system for linking operations of a machine tool and a robot, and includes a transmission side device and a linking destination device, one of which is the machine tool or a controller thereof and the other one of which is the robot or a controller thereof, a reception side device, and a position information acquisition device. The position information acquisition device includes position information generation unit configured to generate position-related information of the transmission side device, and the reception side device includes coordinate transformation unit configured to transform the position-related information to a coordinate system of the reception side device and output the information to the linking destination device.

According to the present invention, a machine tool and robot linking system in which a machine tool and a robot can share information such as positions of each other can be provided.

### BRIEF DESCRIPTION OF THE DRAWINGS

The above-described and other objects and features of the present invention will be clarified from description of embodiments below with reference to attached drawings. Among the drawings:

FIG. 1A is a schematic diagram illustrating an example of a linking system;

FIG. 1B is a schematic diagram illustrating an example of the linking system;

FIG. 2 is a block diagram illustrating a functional configuration of the linking system;

FIG. 3 is a schematic diagram illustrating coordinate transformation processing performed by coordinate transformation unit; and

FIG. 4 is a block diagram illustrating a functional configuration of the linking system.

### DETAILED DESCRIPTION OF THE PREFERRED EMBODIMENTS

A machine tool and robot linking system 100 (simply called a linking system 100, hereinafter) pertaining to an embodiment of the present invention is a system in which a machine tool and a robot notify each other of information regarding a position or the like through a communication infrastructure. Based on such a system, the machine tool and the robot can utilize the information regarding the position or the like and perform appropriate operations while avoiding interference according to the operation of an opposite party.

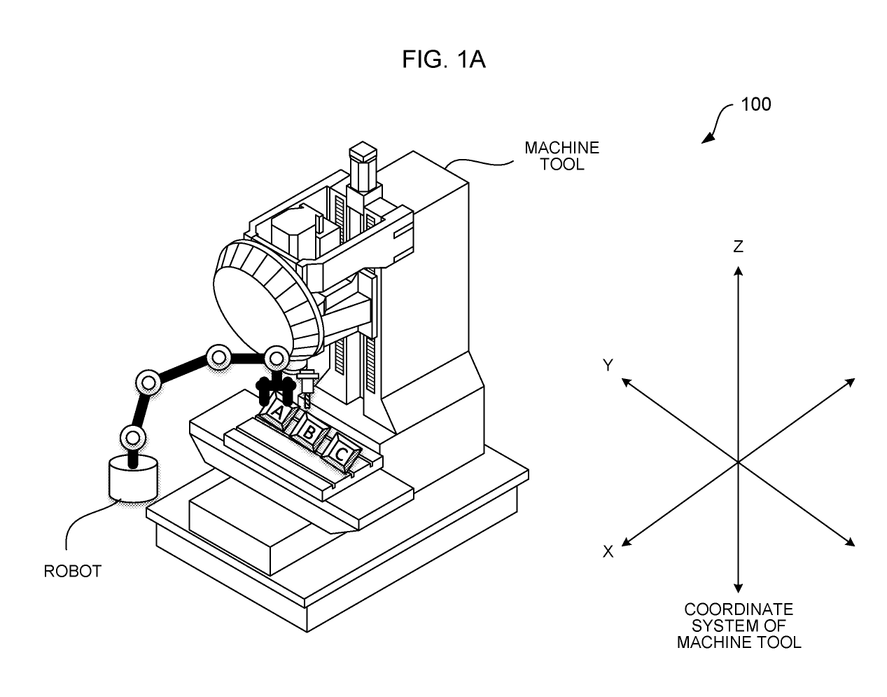

FIG. 1 is a schematic diagram illustrating an example of the linking system 100. As illustrated in FIG. 1A, the linking system 100 includes one machine tool and one robot. The machine tool processes a workpiece A, a workpiece B and a workpiece C in order. It is assumed that a table of the machine tool mounted with the workpiece moves in left, right, front and back directions (X axis and Y axis) within a plane, and a tool moves in a vertical direction (Z axis). When processing of the workpiece A is ended, the machine tool immediately starts processing the workpiece B. While the workpiece B is processed, the robot holds and removes the processed workpiece A, and mounts the next workpiece at a position where the workpiece A was placed. Since the table moves while the machine tool processes the workpiece B, in order for the robot to hold the workpiece A, the operation following movement of the table of the machine tool is required. That is, as illustrated in FIG. 1B, the robot (1) recognizes the movement of the table of the machine tool, (2) moves an arm of the robot following the movement of the table, (3) holds the workpiece while following the movement of the table, and (4) lifts the workpiece from the table. Hereinafter, a functional configuration needed to realize such a linking operation will be specifically described.

### Embodiment 1

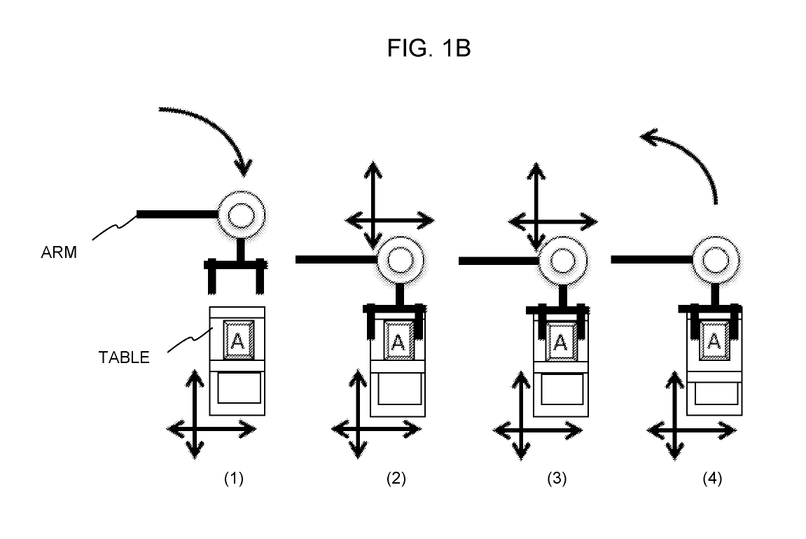

FIG. 2 is a block diagram illustrating a functional configuration of the machine tool and robot linking system 100 (simply called the linking system 100, hereinafter) pertaining to Embodiment 1 of the present invention. The linking system 100 includes a transmission side device 10 and a reception side device 20. The transmission side device 10 is the machine tool or the robot, or a controller thereof. The reception side device 20 is the robot or the machine tool, or a controller thereof performing a linking operation with the transmission side device 10. Alternatively, the reception side device 20 may be another arbitrary information processor, and the reception side device 20 may mediate information between the transmission side device 10 and the machine tool or the robot which is a linking destination device. The reception side device 20 in this case is typically a communication controller or a server device or the like arranged on a communication network. In any form, the transmission side device 10 and the reception side device 20 are communicably connected with each other. As a communication infrastructure, for example, a signal line directly connecting both, and a communication channel capable of transmitting data by a general-purpose communication standard such as Ethernet (R) or by an exclusive communication standard such as an in-factory communication network or the like can be used, but the communication infrastructure is not limited to these examples.

The transmission side device 10 includes a position information generation unit 11 and a transmission unit 13.

The position information generation unit 11 generates position-related information of the transmission side device 10. The position-related information may be an installation position of the machine tool, a position of a tool distal end, or a position of a carrier base to perform feed drive by a ball screw or the like when the transmission side device 10 is the machine tool, and may be a position of an arm distal end or the like when the transmission side device 10 is the robot for example, but the information is not limited thereto. For example, as the information regarding the position of the tool or the carrier base of the machine tool or the information regarding the position of the arm of the robot, the position information generation unit 11 can acquire output of a pulse coder of a servo motor which drives them as the position-related information. Alternatively, the position information generation unit 11 can acquire output from an encoder and a linear scale attached to individual parts of the machine tool or the robot as the position-related information. The encoder is attached to a terminal end of the ball screw for example. The linear scale can be installed, for example, on a side face of the ball screw, the table of the machine tool, or an inner or outer surface of the arm of the robot. Note that the position information generation unit 11 can generate a plurality of kinds of position-related information in parallel.

The transmission unit 13 transmits the position-related information generated by the position information generation unit 11 to the reception side device 20 through the communication infrastructure. The transmission unit 13 may transmit one kind of position-related information, or may combine and transmit a plurality of kinds of position-related information. For example, the output of the pulse coder of the servo motor which moves the machine tool or the robot that is the transmission side device 10 can be inputted to the controller of the robot as the reception side device 20 directly through a signal line as the communication infrastructure. Note that, at the time, the output of the pulse coder may be inputted also to the controller of the machine tool in parallel.

The reception side device 20 includes reception unit 21 and coordinate transformation unit 23.

The reception unit 21 receives the position-related information transmitted from the transmission unit 13 of the transmission side device 10 through the communication infrastructure. For example, in the case where the controller of the robot or the machine tool as the reception side device 20 can monitor and control an additional axis, to an amplifier for the additional axis as the reception unit 21, the output of the pulse coder of the servo motor of the machine tool or the robot that is the transmission side device 10 can be directly inputted. Thus, the reception side device 20 can recognize the movement (pulse) of the transmission side device 10 which is a linking opposite party as the movement (pulse) of the additional shaft. Alternatively, in the case where there is unit capable of transmitting the position-related information of the machine tool or the robot through a general-purpose communication standard such as Ethernet (R) or an exclusive communication standard such as an in-factory communication network, the reception unit 21 may acquire the position-related information transmitted by the unit.

The coordinate transformation unit 23 performs the processing of transforming the position-related information transmitted from the transmission unit 13 of the transmission side device 10 to an expression by its own coordinate system. The machine tool and the robot have respectively different coordinate systems. Therefore, in order to interpret the position-related information received from the transmission side device 10, the coordinate system in which the information is acquired needs to be expressed again by the coordinate system of the reception side device 20. Therefore, the coordinate transformation unit 23 performs the processing of defining a motion axis (for example, a motion axis of the servo motor which drives the tool, the carrier base, or the robot) of the transmission side device 10 using its own coordinates, and outputs the position-related information expressed by its own coordinates.

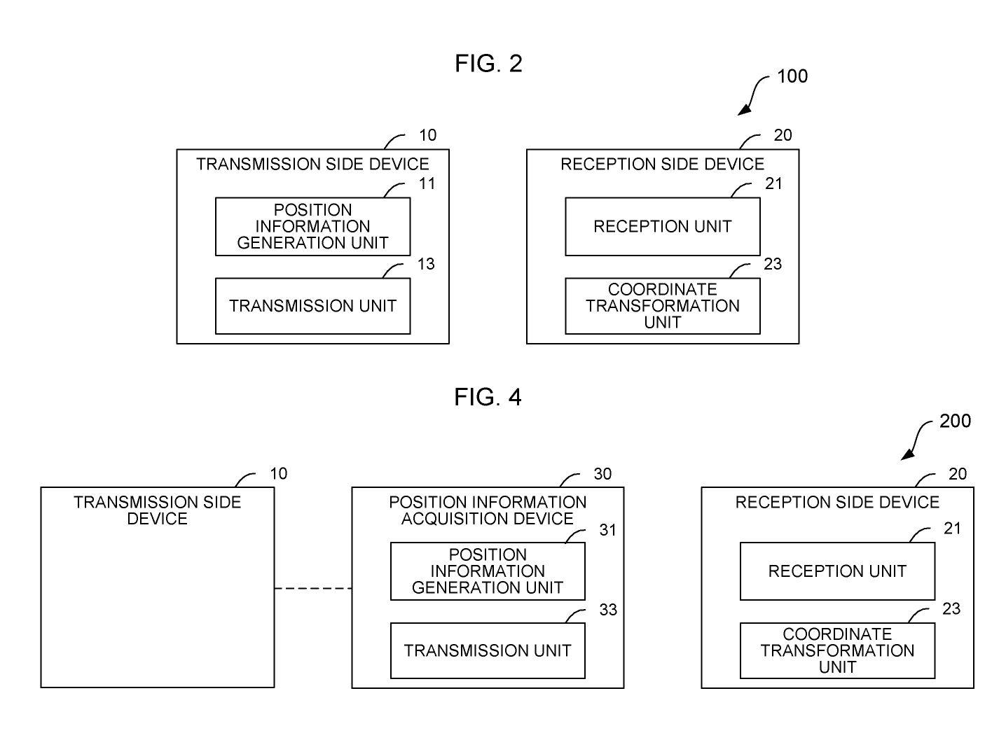

Using FIG. 3, coordinate transformation processing performed by the coordinate transformation unit 23 is illustrated. As illustrated by arrows of thick lines in the figure, the transmission side device 10 and the reception side device 20 have respectively different coordinate systems. The coordinate transformation unit 23 of the reception side device 20 interprets a vector V (illustrated by a thick broken line) indicating one axis in the transmission side device 10 as a composition of two vectors v1 and v2 whose start point is an origin in the coordinate system of the reception side device 20 and whose terminal points are end points of the vector V.

According to the present embodiment, the machine tool or the controller thereof can notify the robot or the controller thereof or another information processor of the position-related information. Alternatively, the robot or the controller thereof can notify the machine tool or the controller thereof or another information processor of the position-related information. Then, the machine tool or the robot or the controller thereof can redraw the position-related information received from the opposite party to its own coordinate system and interpret the information. Thus, the machine tool and the robot can recognize the operation of the robot or the machine tool which is the linking opposite party so that various kinds of control for avoiding the interference can be performed using recognized contents. Thus, productivity can be improved. In addition, system-up can be easily executed.

Note that a control method for avoiding the interference after the position-related information of the linking opposite party is recognized is out of a scope of the present invention. Some known technologies exist in connection with such a control method (Japanese Patent Laid-Open No. 8-202419 and others).

### Embodiment 2

Embodiment 1 illustrates an example in which the position information generation unit 11 of the transmission side device 10 acquires the position-related information of the present device. Embodiment 2 is characterized by a point that a newly provided position information acquisition device 30 acquires the position-related information of the transmission side device 10.

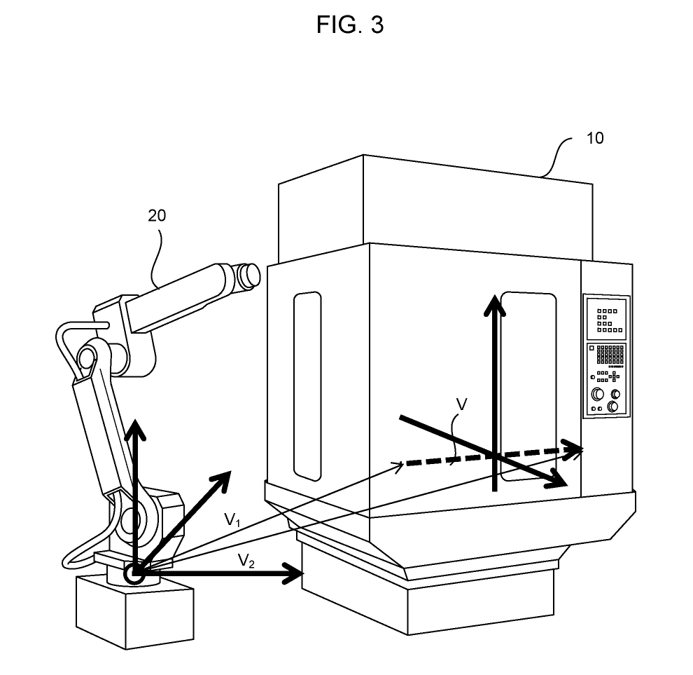

FIG. 4 is a block diagram illustrating a functional configuration of a machine tool and robot linking system 200 (simply called a linking system 200, hereinafter) pertaining to Embodiment 2 of the present invention. The linking system 200 includes the transmission side device 10, the reception side device 20 and the position information acquisition device 30. The transmission side device 10 is the machine tool or the robot. The reception side device 20 is the robot or the machine tool, or the controller thereof, or another arbitrary information processor performing the linking operation with the transmission side device 10. The position information acquisition device 30 monitors the transmission side device 10 and acquires the position-related information. The position information acquisition device 30 and the reception side device 20 are communicably connected with each other through the communication infrastructure.

The transmission side device 10 in Embodiment 2 does not include the position information generation unit 11 and the transmission unit 13. Instead, the position information acquisition device 30 includes position information generation unit 31 and transmission unit 33.

The position information generation unit 31 generates the position-related information of the transmission side device 10. For example, the position information generation unit 31 includes an image pickup device (camera), and obtains the position-related information by photographing the movement of the transmission side device 10 by the image pickup device. In this case, a marker is installed beforehand at a specific point (the table, the carrier base or the tool distal end or the like for the machine tool and the arm or the like for the robot) of the transmission side device 10. The position information generation unit 31 photographs an image including the marker in a predetermined cycle, and generates the position-related information based on the position of the marker within the image.

The transmission unit 33 transmits the position-related information generated by the position information generation unit 31 to the reception side device 20. For example, the position-related information of the machine tool or the robot can be transmitted through a general-purpose communication standard such as Ethernet (R) or an exclusive communication standard such as an in-factory communication network.

The reception side device 20 includes the reception unit 21 and the coordinate transformation unit 23. The operations of the reception unit 21 and the coordinate transformation unit 23 are basically similar to that in Embodiment 1 so that detailed description is omitted.

Note that the position information acquisition device 30 and the reception side device 20 may be one device. That is, the machine tool or the robot or the controller thereof may include image pickup unit or the like as the position information generation unit 31 and acquire the position-related information of the transmission side device 10. In this case, the transmission unit 33 and the reception unit 21 are not necessarily required, and the output of the position information generation unit 31 may be inputted to the coordinate transformation unit 23 as it is.

According to the present embodiment, the information regarding the position can be outputted to the reception side device 20 without providing a sensor on the side of the transmission side device 10 or connecting a signal line.

### Embodiment 3

Embodiments 1 and 2 illustrate an example in which the position information generation unit 11 (31) acquires the output of the pulse coder or the encoder as the position-related information. Embodiment 3 is characterized by the point that the position information generation unit 11 (31) converts the output to speed data. Then, the coordinate transformation unit 23 specifies the position of the opposite party based on the speed data. The other components are similar to those in Embodiments 1 and 2 so that the detailed description is omitted in the present embodiment.

Based on the output of the pulse coder or the encoder acquired within predetermined time, the position information generation unit 11 (31) calculates a speed of the specific point (the table, the carrier base or the tool distal end or the like for the machine tool and the arm or the like for the robot) of the transmission side device 10. The position information generation unit 11 (31) outputs the data of the calculated speed to the reception side device 20.

The coordinate transformation unit 23 of the reception side device 20 calculates the position of the specific point of the transmission side device 10 based on the received speed data. Here, it is assumed that the coordinate transformation unit 23 holds a stroke (movable range) of a movable part (for example, the table, the tool or the carrier base or the like of the machine tool) of the transmission side device 10 beforehand. In addition, it is assumed that the coordinate transformation unit 23 holds coordinates of an end to be a base point of both ends of the movable part (typically, both ends of the ball screw). When the information (the speed data, the stroke and the end coordinates) is used, the coordinate transformation unit 23 can calculate the position of the specific point of the transmission side device 10.

According to the present embodiment, the position-related information of the machine tool or the robot can be easily specified by relatively simple calculation in the reception side device 20.

Embodiments of the present invention have been described above, but the present invention is not limited only to the examples of the embodiments described above, and can be implemented in various forms by adding appropriate changes.

1. A linking system for linking operations of a machine tool and a robot, comprising:
a transmission side device and a reception side device, one of which is the machine tool or a controller thereof and the other one of which is the robot or a controller thereof,
wherein the transmission side device includes
a position information generation unit configured to generate position-related information of the transmission side device and
a transmission unit configured to transmit the position-related information to the reception side device, and
the reception side device includes
a reception unit configured to receive the position-related information from the transmission side device and
a coordinate transformation unit configured to transform the position-related information to a coordinate system of the reception side device.

2. The linking system according to claim 1,
wherein the position-related information is output of a pulse coder or an encoder of the transmission side device.

3. A linking system for linking operations of a machine tool and a robot, comprising:
a transmission side device and a reception side device, one of which is the machine tool or a controller thereof and the other one of which is the robot or a controller thereof, and a position information acquisition device,
wherein the position information acquisition device includes
a position information generation unit configured to generate position-related information of the transmission side device, and
the reception side device includes
a coordinate transformation unit configured to transform the position-related information to a coordinate system of the reception side device.

4. The linking system according to claim 3, wherein the position information acquisition device includes image pickup unit configured to acquire an image of the transmission side device, and the position information generation unit generates the position-related information based on the image.

5. A linking system for linking operations of a machine tool and a robot, comprising:
a transmission side device and a linking destination device, one of which is the machine tool or a controller thereof and the other one of which is the robot or a controller thereof, and a reception side device,
wherein the transmission side device includes
a position information generation unit configured to generate position-related information of the transmission side device and
a transmission unit configured to transmit the position-related information to the reception side device, and
the reception side device includes
a reception unit configured to receive the position-related information from the transmission side device, and
a coordinate transformation unit configured to transform the position-related information to a coordinate system of the reception side device and output the information to the linking destination device.

6. A linking system for linking operations of a machine tool and a robot, comprising:
a transmission side device and a linking destination device, one of which is the machine tool or a controller thereof and the other one of which is the robot or a controller thereof, a reception side device, and a position information acquisition device,
wherein the position information acquisition device includes
a position information generation unit configured to generate position-related information of the transmission side device, and
the reception side device includes
a coordinate transformation unit configured to transform the position-related information to a coordinate system of the reception side device and output the information to the linking destination device.
